(19) United States
(12) Patent Application Publication
(10) Pub. No.: US 2023/0169268 A1
(43) Pub. Date: Jun. 1, 2023

(54) TEXTUAL ADJUSTMENT TO A TARGET READING LEVEL

(71) Applicant: PlaBook, Lee's Summit, MO (US)

(72) Inventor: Philip William Van Hickman, Lee's Summit, MO (US)

(21) Appl. No.: 18/075,693

(22) Filed: Dec. 6, 2022

Related U.S. Application Data
(63) Continuation-in-part of application No. 17/965,471, filed on Oct. 13, 2022.
(60) Provisional application No. 63/255,806, filed on Oct. 14, 2021.
(60) Provisional application No. 63/264,972, filed on Dec. 6, 2021.

(51) Int. Cl. G06F 40/247; G09B 17/00; G10L 15/26; G10L 15/01

(52) U.S. Cl. CPC G06F 40/247; G09B 17/003; G10L 15/26; G10L 15/01

(57) ABSTRACT

The technology described herein helps a student learn how to read by providing text at a reading level suitable for learning. The technology described herein can take an input text and adjust the reading level to match the target reading level. The text can be adjusted through word substitution. Prior to outputting the complexified text, a grammar check can determine that the substitution did not generate a grammatically incorrect complexified text.

### CROSS-REFERENCE TO RELATED APPLICATIONS

This application is a continuation-in-part of U.S. patent application Ser. No. 17,965,471, filed Oct. 13, 2022, which application claims the benefit of U.S. Provisional Application No. 63/255,806, filed Oct. 14, 2021, and U.S. Provisional Application No. 63/264,972, filed Dec. 6, 2021. The entirety of all three applications is hereby incorporated by reference.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

The technology described herein adjusts the reading level of an input text to a target reading level calculated to help the user improve their reading ability. The reading level of an input text may be increased or decreased. In one aspect, the text difficulty level is increased to just above the reader's current reading level. The reading level of an input text may be adjusted by substituting words in the text with synonyms that are more or less complex. Substituting complex synonyms into the text will increase the reading level, while less complex synonyms will decrease the reading level.

The technology described herein can provide fine control over the reading level of text provided to a reader by substituting several words to make a large change or just a few words to make a small change. Similarly, the complexity level of various synonyms can be considered when making the substitution. In order to optimize the learning opportunity when students read books or other text, ideally the student would constantly be challenged with vocabulary text that was 2 to 3% more difficult than their current reading level. In contrast, most texts used in education are targeted broadly at a particular grade level. The broad targeting results in a lack of challenge and engagement for some students when the text provided is below their reading level, while other students struggle when presented with text above their reading level. Further, the jump in difficulty from one grade level to the next may discourage some students. The technology described herein allows for an incremental increase to a level between existing reading levels that avoids the discouragement. The technology described herein also allows text written for one level to be reused at other levels.

### BRIEF DESCRIPTION OF THE DRAWINGS

The technology described herein is illustrated by way of example and not limitation in the accompanying figures in which like reference numerals indicate similar elements and in which:

FIG. 1 is a block diagram of an example operating environment suitable for implementations of the present disclosure;

FIG. 2 is a diagram depicting an example automated reading instruction system suitable for implementing aspects of the present disclosure;

FIG. 3 is a diagram depicting an example reading interface system suitable for implementing aspects of the present disclosure;

FIG. 4 is a diagram depicting an example assignment interface suitable for implementing aspects of the present disclosure;

FIG. 5 is a diagram depicting an example reading-progress interface suitable for implementing aspects of the present disclosure;

FIG. 6 is a diagram depicting an example reading interface suitable for implementing aspects of the present disclosure;

FIG. 7 is a diagram depicting an example reading-analysis interface suitable for implementing aspects of the present disclosure;

FIG. 8 is a diagram depicting an example phonemes-analysis interface suitable for implementing aspects of the present disclosure;

FIG. 9 is a diagram depicting an example error-correction interface suitable for implementing aspects of the present disclosure;

FIG. 10 is a diagram depicting an example error-type analysis interface suitable for implementing aspects of the present disclosure;

FIG. 11 is a diagram depicting an example teacher interface suitable for implementing aspects of the present disclosure;

FIG. 12 is a diagram depicting an example automated reading-level adjustment system suitable for implementing aspects of the present disclosure;

FIG. 13 is a diagram of a flow chart showing a reading-level adjustment method, according to aspects of the present disclosure;

FIG. 14 is a diagram of a flow chart showing a reading-level adjustment method, according to aspects of the present disclosure;

FIG. 15 is a diagram of a flow chart showing a reading-level adjustment method, according to aspects of the present disclosure; and

FIG. 16 is a block diagram of a computing environment suitable for use in implementing aspects of the technology described herein.

### DETAILED DESCRIPTION

The various technologies described herein are set forth with sufficient specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

The technology described herein adjusts the reading level of an input text to a reading level calculated to help the user improve their reading ability. Typically, in real learning situations, a reader would start with something simple and increase the complexity as learning increases, which is the opposite of how some existing systems work. While text adjustment systems are known, existing systems frequently perform word replacement without regard for semantics or context. Existing systems replace words from all parts of speech without checking their part of speech, so some structural words (auxiliary verbs, conjunctions, prepositions, etc.) may be replaced. Replacing structural words may make a sentence semantically nonsensical. In addition, the words are replaced without taking into consideration their context, which may affect the meaning of a final sentence.

The technology described herein, which uses increasing complexity of texts, aligns with how people naturally learn by starting simply and increasing complexity as skills increase. This incremental approach results in significant improvement in learning outcomes, efficiency and speed. Additionally, the technology described herein uses multiple sources of synonym identification, which takes context and semantics into consideration when selecting the appropriate synonym for substitution. In aspects, the technology described herein gives the opportunity to choose words from among three parts of speech (adjectives, verbs, nouns) for replacement.

The technology described herein may start the text adjustment process by receiving a textual content. The textual content may be a book, news article, blog post, short story, or any other textual content. The textual content may be provided in electronic format, such as in a PDF format, WORD format, HTML, and the like. If the textual content is received in a tangible format, such printed on paper, then the textual content may be scanned and converted to editable text via an optical character recognition process.

Next, an initial reading level of the textual content may be determined. Alternatively, the reading level of the text may be provided. A desired reading level that is different from the initial reading level may be received. The desired reading level may be based on a reading level determined for a reader. In one aspect, the reading level for a reader may be the MSV score described herein. The MSV score may be mapped to a reading level schema to enable use of the MSV score for selecting the desired reading level. The desired reading level may be set one or two increments above the reading level equivalent to the MSV score.

The desired reading level may be provided through a user interface that provides selectable reading levels. For example, the selectable reading levels for a text could be 7.1, 7.2, 7.3, 7.4, and so on. These example-reading levels increase the 7^{th} grade reading level by 10% of the 8^{th} grade reading level incrementally. In other words, 7.1 is not necessarily 10% more difficult than the 7^{th} grade reading level, but 10% of the difficulty difference between the 7^{th} and 8^{th} grade reading levels.

Once the input reading level and the desired reading level are determined, the technology described herein adjusts the text to match the desired reading level. Conceptually, the initial reading level is used to determine how many words need to be substituted to adjust the textual input to the desired reading level. The initial reading level and desired reading level can also be inputs to determining the complexity of the synonyms eventually selected. The first part of the adjustment process may be to assign parts of speech to words in the textual content. Once the parts of speech are determined, then target words within the text may be identified for substitution. These words may be limited to certain parts of speech, such as nouns, verbs, and adjectives.

Once the target words are identified, candidate replacement words that are synonyms for the target words are identified. The candidate replacement words may be limited to the same grammatical category (part of speech) as the target word. Thus, a noun target word would be replaced with a noun candidate word.

Once the candidate replacement words are identified, a reading complexity for the candidate replacement words is determined. In aspects, the complexity level may be retrieved from a data record with complexity levels assigned various words. The complexity level is used to select words to substitute with words in the input text. Initially, a heuristic may be used to select the complexity of candidate words and an amount of candidate words to substitute. The heuristic may map various candidate words to a reading level adjustment that will occur with each word, given an initial reading level of the text. The heuristic may also exclude candidate words with above a threshold complexity for use with certain desired reading levels. This prevents inappropriately complex words from being used as substitute words.

Once the candidate words are selected based on the assigned complexity level, a candidate replacement text is generated by substituting one or more target words in the textual content with one or more candidate replacement words. Not all target words originally identified need to be replaced. A grammar check may then be run on the candidate replacement text and grammatical changes made as needed. Alternatively, a candidate replacement text with an identified problem may be rejected completely, or in part, and a new candidate replacement text generated. The new candidate replacement text may be generated with a limitation that prevents substitution with one or more candidate words associated with a portion of text with an identified grammatical problem.

As an additional quality check, an updated reading level for the candidate replacement text may be determined using the same system that generated the initial reading level. If the updated reading level is within a threshold of the desired reading level, then the candidate replacement text may be output to the user. If outside the threshold, then the candidate replacement text may be adjusted by undoing a replacement, making a new replacement, or updating a replacement with more complex or less complex candidate word.

Having briefly described an overview of aspects of the technology described herein, an operating environment in which aspects of the technology described herein may be implemented is described below in order to provide a general context for various aspects.

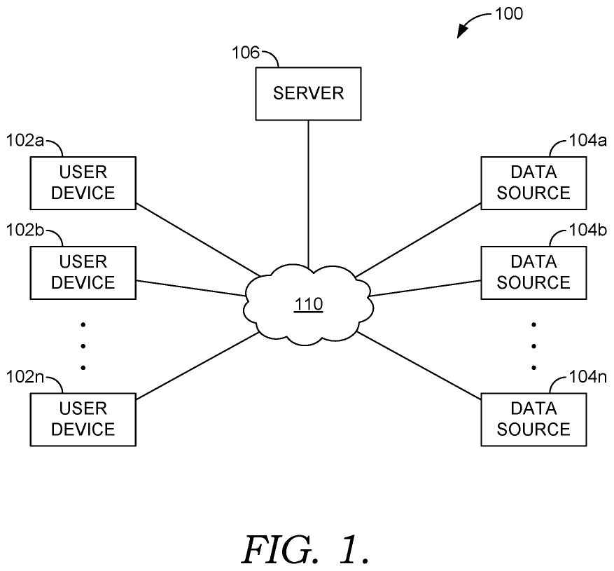

Turning now to FIG. 1, a block diagram is provided showing an example operating environment 100 in which some aspects of the present disclosure may be employed. It should be understood that this and other arrangements described herein are set forth only as examples. Other arrangements and elements (e.g., machines, interfaces, functions, orders, and groupings of functions, etc.) may be used in addition to or instead of those shown, and some elements may be omitted altogether for the sake of clarity. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, some functions may be carried out by a processor executing instructions stored in memory.

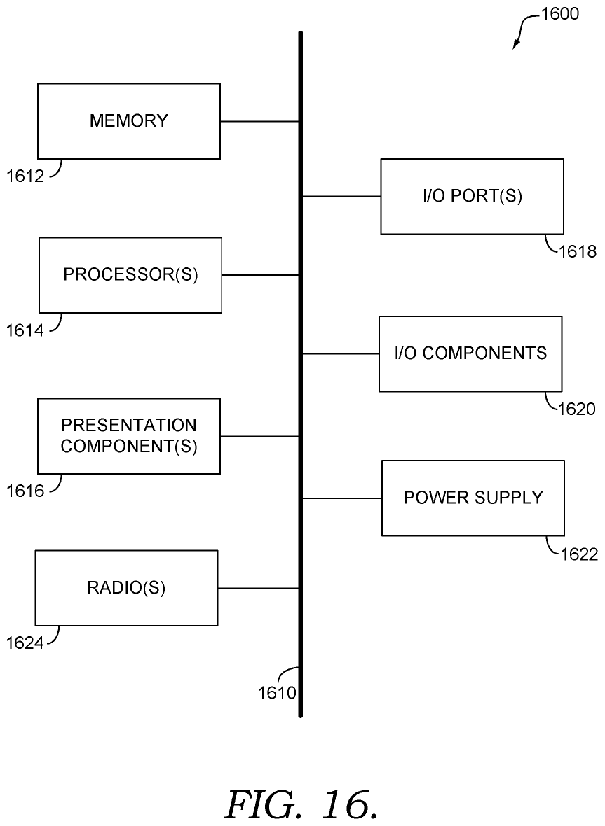

Among other components not shown, example operating environment 100 includes a number of user devices, such as user devices 102a and 102b through 102n; a number of data sources, such as data sources 104a and 104b through 104n; server 106; and network 110. Each of the components shown in FIG. 1 may be implemented via any type of computing device, such as computing device 1600 described in connection to FIG. 16, for example. These components may communicate with each other via network 110, which may include, without limitation, one or more local area networks (LANs) and/or wide area networks (WANs). In example implementations, network 110 comprises the Internet and/or a cellular network, amongst any of a variety of possible public and/or private networks.

User devices 102a and 102b through 102n may be client devices on the client-side of operating environment 100, while server 106 may be on the server-side of operating environment 100. The user devices may facilitate output of text for a student to read aloud and recording the student's reading in an audio file. The audio file that contains the student's oral reading may be communicated to other components of the system, such as the error identifier 220. In another aspect, the user devices 102a connect to a webpage or other remote application that receives an audio stream of the user reading. The user devices may run applications that facilitate the technology described herein. In one aspect, the technology runs entirely on a user device 102. In other aspects, a hybrid model is used where components of the technology reside on the server side of the environment 100, while interactions occur through the user devices 102. The devices may belong to many different users and a single user may use multiple devices.

Server 106 may comprise server-side software designed to work in conjunction with client-side software on user devices 102a and 102b through 102n to implement any combination of the features and functionalities discussed in the present disclosure. For example, the server 106 may run the reading instruction system 200, which assigns a reading level to a reading attempt and/or provides error feedback. The server 106 may receive digital assets, such as files of documents, audio files, video files, emails, social media posts, user profiles, and the like for storage, from a large number of user devices belonging to many users. This division of operating environment 100 is provided to illustrate one example of a suitable environment, and there is no requirement for each implementation that any combination of server 106 and user devices 102a and 102b through 102n remain as separate entities.

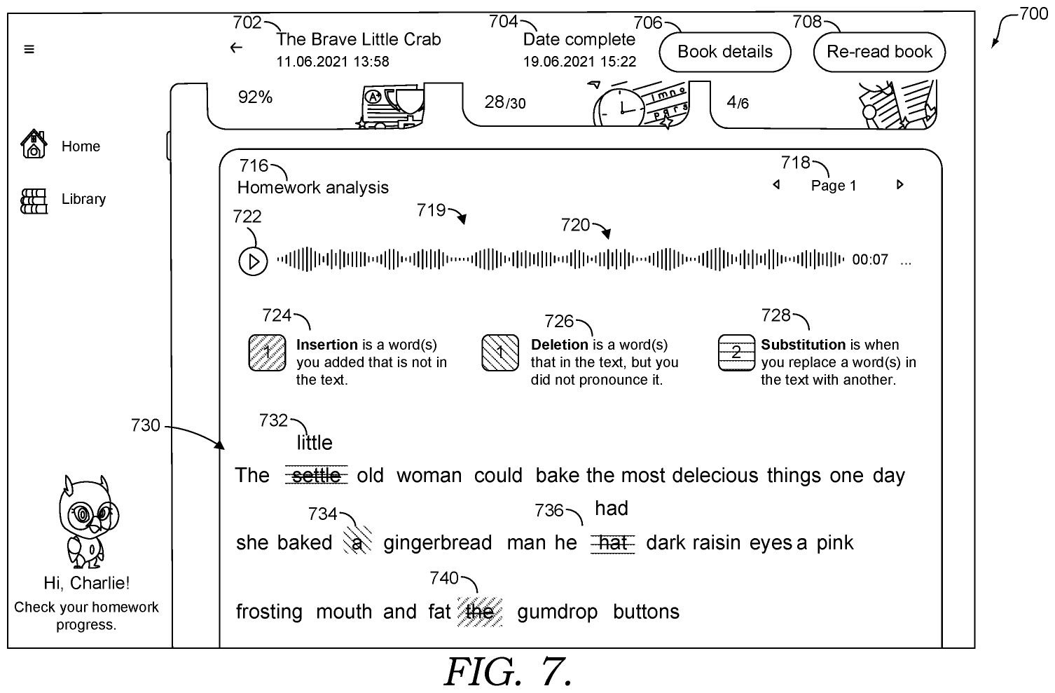

User devices 102a and 102b through 102n may comprise any type of computing device capable of use by a user. For example, in one aspect, user devices 102a through 102n may be the type of computing device described in relation to FIG. 7 herein. By way of example and not limitation, a user device may be embodied as a personal computer (PC), a laptop computer, a mobile device, a smartphone, a tablet computer, a smart watch, a wearable computer, a fitness tracker, a virtual reality headset, augmented reality glasses, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

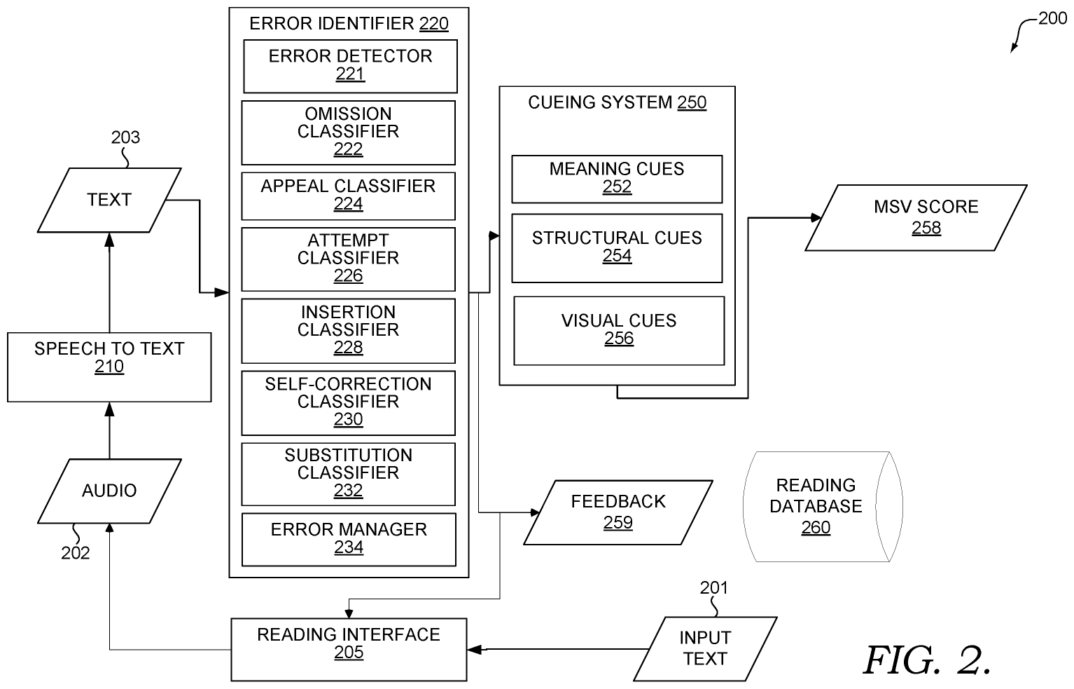

Data sources 104a and 104b through 104n may comprise data sources and/or data systems, which are configured to make data available to any of the various constituents of operating environment 100, or reading instruction system 200 described in connection to FIG. 2. For example, the data sources may comprise text to be read by a student, an audio file of storing a recording of a student reading, a video file storing a video of a student reading, a reading assessment, an error report, and other data items described herein. Data sources 104a and 104b through 104n may be discrete from user devices 102a and 102b through 102n and server 106 or may be incorporated and/or integrated into at least one of those components.

Operating environment 100 may be utilized to implement one or more of the components of reading instruction system 200, described in FIG. 2, including components for collecting user data, collecting reading attempts, scoring reading attempts, and providing feedback.

Referring now to FIG. 2, with FIG. 1, a block diagram is provided showing aspects of an example computing system architecture suitable for implementing some aspects of the present disclosure and designated generally as reading instruction system 200. Reading instruction system 200 represents only one example of a suitable computing system architecture. Other arrangements and elements may be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Reading instruction system 200 includes reading interface 205, speech-to-text component 210, error identifier 220 (and its components 221, 222, 224, 226, 228, 230, 232, 234), and cueing system 250 (and its components 252, 254, 256). These components may be embodied as a set of compiled computer instructions or functions, program modules, computer software services, or an arrangement of processes carried out on one or more computer systems, such as computing device 1600 described in connection to FIG. 16, for example. The components can use one or more application program interfaces (API) to communicate with each other. The APIs may allow the components to communicate with programs and program components not shown in FIG. 2.

In one aspect, the functions performed by components of reading instruction system 200 are associated with one or more applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of reading instruction system 200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein may be performed, at least in part, by one or more hardware logic components. For example, and without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with reference to specific components shown in example reading instruction system 200, it is contemplated that in some aspects functionality of these components may be shared or distributed across other components.

Several data items are also shown in FIG. 2. These data items include input text 201, audio data 202, converted text 203, MSV score 258, and feedback report 259. These data items include the systems inputs and outputs. Initially, input text 201 is output for display through the reading interface 205. The input text 201 may be part of a reading assignment. The reading instruction system 200 can include a corpus of input texts for students to read. In one aspect, the corpus of input texts are stored in reading database 260. In aspects, the input texts can be documents, webpages, book excerpts, books, and the like.

The reading interface 205 can be a dedicated application-specific interface, such as provided by a reading application running on a smart phone, tablet, e-reader, laptop, or other user device. A reading application is an application specifically designed to help a student read. In another aspect, the reading interface 205 can be provided by a web browser or other software running on a user device. For example, the reading interface 205 could be a plug-in or other add-on to an e-reading application, a document application, or other content presentation application.

The reading interface 205 captures audio data 202 of a student reading the input text 201. The audio data 202 could be an audio file that stores all proportion of the audio recording of the user reading. In another aspect, the audio data 202 takes the form of audio stream communicated from the user device on which the reading interface 205 is output over a network to a device hosting the speech-to-text component 210. In aspects, the speech-to-text 210 component can reside on the user device. The speech-to-text component 210 converts the audio data 202 into converted text 203 that represents a textual version of the words and other sounds (if any) spoken by the student and recorded in the audio data 202. In one aspect, the speech-to-text component 210 does not employ natural language understanding technology that does not resolve ambiguous audio sounds according to a language model or understood grammar. Using such a model may eliminate some errors made in the oral reading attempt and a goal of the technology herein is to capture any errors made. Accordingly, aspects of the technology may use speech-to-text technology that produces closer to a phonetic or literal conversion of the oral reading attempt. The audio data may be stored in a file for later use, including for replay to the student, teacher, or parent.

The converted text 203 is then input to the error identifier 220 along with the input text 201. The error identifier 220 identifies and classifies errors found within the converted text 203 and provides the classified errors to the cueuing system 250, which in turn generates an MSV (meaning, structural, and visual cues) score 258. The MSV score 258 may be provided to the user through the reading interface 205, through an email, through text, or through some other mechanism. The MSV score may also be used by other components (not shown) to select and/or generate future reading assignments for a student. The MSV score 258 may be associated with the user via a user profile stored in the reading database 260 or elsewhere. The MSV score is a type of proficiency score.

The identified errors and their associated classifications can be used to generate a feedback report 259. The feedback report can be provided to the user through the reading interface 205 or through some other mechanism. In one aspect, the feedback report shows all or parts of both the input text 201 in the converted text 203. Where the input text 201 and the converted text 203 agree, a single text line may be shown. Where an error is detected in the converted text 203, the input text 201 will not agree with the converted text 203. For this portion, the portion of converted text 203 containing the error may be displayed on top of the corresponding input text 201. This allows the student to see the input text being read and the converted text representing the student's oral reading attempt. The classification of the error may be communicated with a label, color-coding, or some other method.

TABLE 1 shown below includes a possible reading report.

TABLE 1

| | |
|---|---|
| Actual Sentence | Kyle and Emma were playing in the snow. |
| | It was the kind of snow that was perfect |
| | for making snowballs. They talked about |
| | building a fort or having a snowball fight. |
| | “How about we make a snowman?” |
| | Kyle asked Emma. “Let's make the |
| | biggest snowman ever!” |
| Converted Reader Audio | Count Kyle and Emma were playing in the |
| | snow it was kind of snow that was perfect |
| | for making snowballs. They talked about |
| | building a fort or having a snowball fight. |
| | How about we make a snowman called as |
| | Emma. lets make the biggest snowman ever |
| Analyzed Reading | {I -count}Kyle and Emma were playing |
| Output | in the snow it was {{D-the}} kind |
| | of snow that was perfect for making snowballs. |
| | They talked about building a fort {{S-for}} |
| | or having a snowball fight. How about we |
| | make a snowman {{S-Kyle}} called |
| | as{{S-asked}} Emma. lets make |
| | the biggest snowman ever |

As can be seen, table 1 shows the converted text, the actual text, and a reading output that labels the error according to the category into which the error was classified. In this non-limiting example, the following labels are used. Insertions (I), Omissions/Deletions (D) and Substitutions (S).

The error identifier 220 identifies errors in an oral reading attempt, as reflected in the converted text 203, and assigns a classification to each error. The error identifier 220 includes an error detector 221, an omission classifier 222, an appeal classifier 224, an attempt classifier 226, an insertion classifier 228, a self-correction classifier 230, a substitution classifier 232, and error manager 234.

The error detector 221 detects differences between the input text 201 and the converted text 203. In one aspect, any difference is classified as an error. Once the error is identified, it is classified into a category. Though shown as a series of components, the classification could be done by a single component, such as a multi-class classifier. A multi-class classifier is a machine learning technology that receives training data comprising labeled errors. For example, a substitution could be shown and labeled. The training data could comprise a sample input text and a sample converted text. During training, the training data is input to the classifier until the classifier is able to correctly assign a classification to an unlabeled error. The classification may take the form of a class confidence score. In one aspect, a transformer model is used to assign the error classification. Various heuristic approaches are also possible and a combination of heuristics and machine learning are possible.

The omission classifier 222 identifies errors of omission, which occurs when a word in the input text 201 is not read by the reader. Omissions may be detected by a heuristic that looks for a missing word or multiple missing words. When the error fits the omission pattern then the error may be classified as an omission.

The appeal classifier 224 identifies appeals, which are requests by the reader for help. For example, the reader may ask, “what is this word?” This may be considers as a type of insertion where words not in the input text 201 are found in the converted text 203. In addition, a determination may be made that other words are not missing from the surrounding text. If words are missing, then a substitution may have occurred. A heuristic approach may look for commonly asked questions in the inserted text. If the inserted text does not match a commonly asked question, then it may be classified as an insertion, but not an appeal. The heuristic could look for an insertion in the form of a question (for example a clause starting with who, what, when, where, why, or how) could indicate a question is being asked.

The attempt classifier 226 identifies an aborted attempt to read a word. This may also be described as hesitation. The attempt could initially be a type of insertion where extra words or sounds not forming a word are in the converted text. A heuristic could look for phonetic sounds similar to those in the word coming after the attempt and identify an attempt. If the user goes on to skip the word, then an attempt with an omission could be detected.

The insertion classifier 228 detects an insertion. An insertion occurs when words that are not in the input text 201 occur in the converted text 203. An error may be classified as an insertion, when the extra words are not an attempt, self correction, or appeal, which are two specific types of insertions.

The self-correction classifier 230 occurs when the reader repeats a portion of the text where an error was previously made. The self-correction is a type of insertion and will be detected as an error because of extra words in the converted text 203. A heuristic could identify a self-correction when the inserted words include one or more words from the input text that are in a phrase where an error occurred.

The substitution classifier 232 detects a substitution, which occurs when one words is substituted for another word.

The error manager 234 keeps a running record of the errors being made and a classification assigned to the errors. These errors may be output in near real time in a running reading record report.

The cueing system 250 assigns a competency score, shown as MSV score 258, to the oral reading attempt using the errors identified and classified by the error identifier 220. Components of the curing system 250 include the meaning cues component 252, the structural cues component 254, and the visual cues component 256. The MSV score is a combination of the meaning cues, structural cues, and visual cues found in the identified errors.

The meaning cues component 252 identifies meaning clues using the output from the error identifier 220. The meaning cue could be output as a score. A strong meaning cue detected in the error could result in a high score and a low meaning cue a low score. The input text 201 and converted text 203 may also be inputs to the meaning cues component 252. Meaning cues, also known as semantic cues, typically use the reader's knowledge of the real world to help the reader determine appropriate words in context. An example might be “John put the food in the ______.” Based on the reader's knowledge of how the world works, the word “bowl” would be more likely than the word “bawl.” In other words, the meaning clues attempt to determine if a word used in the error makes sense given the surrounding words. If the word does not make sense, then a low meaning cue score could be assigned. The low score might indicate the reader is not using context to help read the passage.

The structural cues component 254 identifies structural clues using the output from the error identifier 220. The input text 201 and converted text 203 may also be inputs to the structural cues component 254. The structural cue could be output as a score. A strong structural cue detected in the error could result in a high score and a low structural cue a low score. Structural cues, also known as Syntactic cues, factor in things like grammar, punctuation and word order to help a reader identify the likely words. In a sentence like “The ______ ate the food.” The sequence would cue the reader structurally that the word they are looking for is likely to be a noun. In other words, the structural clues attempt to determine if a word used in the error makes sense grammatically given the surrounding words. If the word does not make sense grammatically, then a low structure cue score could be assigned. For example, if the reader made an error my including a verb or adjective in the above sentence, then a low structural score could be assigned. The low score might indicate the reader is not using grammar context to help read the passage.

The visual cues component 256 identifies visual clues using the output from the error identifier 220. The input text 201 and converted text 203 may also be inputs to the visual cues component 256. Visual Cues, also known as Graphophonic Cues, use letter-sounds to try to help the reader determine the word. An example visual cue occurs when a reader tries to sound out a word by looking at the visual patterns in a word. If the word or words in the error do not have the same sounds as the correct word, then a low visual cue score could be assigned. Conversely, if the word or words in the error have similar sounds to those in the original text, then a high visual cue score could be assigned.

The MSV can be a grouping each cue score. In other words, the MSV score can have three attributes and three corresponding scores. The three attributes (MSV) could be combined in a weighted combination to determine a final MSV score. The MSV score could serve as an overall reading competency score. The MSV could be combined with other factors, such as the total number of errors, the reading level of the input text, and other factors to determine a separate competency score. The individual components of the MSV score can help teachers selected assignments that address a student's weakness.

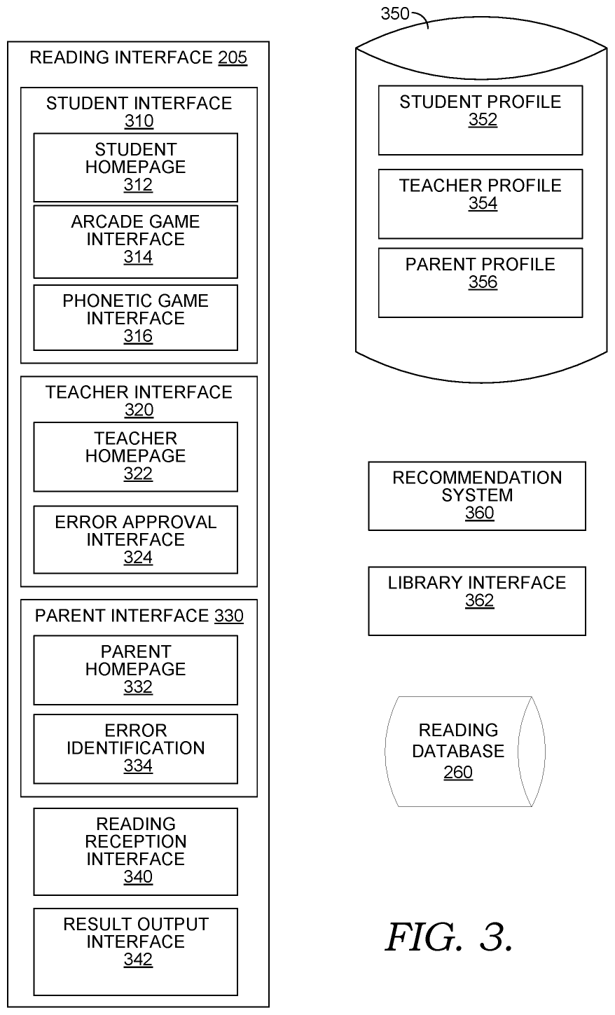

Turning now to FIG. 3, a diagram depicting an example reading interface system suitable for implementing aspects of the present disclosure is provided. Reading interface system 300 represents only one example of a suitable computing system architecture. Other arrangements and elements may be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Reading interface system 300 includes the reading interface 205 (and its components 310, 312, 314, 316, 320, 322, 324, 330, 332, 334, 340, and 342), user profile store 350 (and its components 352, 354, and 356), recommendation system 360, and library interface 362. These components may be embodied as a set of compiled computer instructions or functions, program modules, computer software services, or an arrangement of processes carried out on one or more computer systems, such as computing device 1600 described in connection to FIG. 16, for example. The components can use one or more application program interfaces (API) to communicate with each other. The APIs may allow the components to communicate with programs and program components not shown in FIG. 3.

In one aspect, the functions performed by components of reading interface system 300 are associated with one or more applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of reading interface system 300 may be distributed across a network, including one or more servers (such as server 106) and client devices (such as user device 102a), in the cloud, or may reside on a user device, such as user device 102a.

The reading interface component 205 generates a series of interfaces that help users, such as students learn to read. The series of interfaces can also help teachers and parents assign reading work to students and monitor student progress. The interfaces can help students better understand their reading performance. Aspects of the technology described herein are not limited to the interfaces described with reference to FIG. 3.

The student interface 310 includes an assignment interface component 312, arcade game interface component 314, and phonetic game interface component 316. As an initial step in a user may provide credentials to login. In order to login, a student may provide a username, password, biometric input, or some other credential. Upon logging in, the student may be given access to interfaces and resources within the reading instruction system to which the student is authorized to access. The interfaces and resources that a given student is authorized to access may be managed using information in the student profile 352. The student profile may associate the student with a particular user ID that is in turn associated with the student's past reading assignments, in-progress reading assignments, assigned reading assignments, rewards, and the like. Links to the resources and interfaces that a student can access may be provided on the student's homepage.

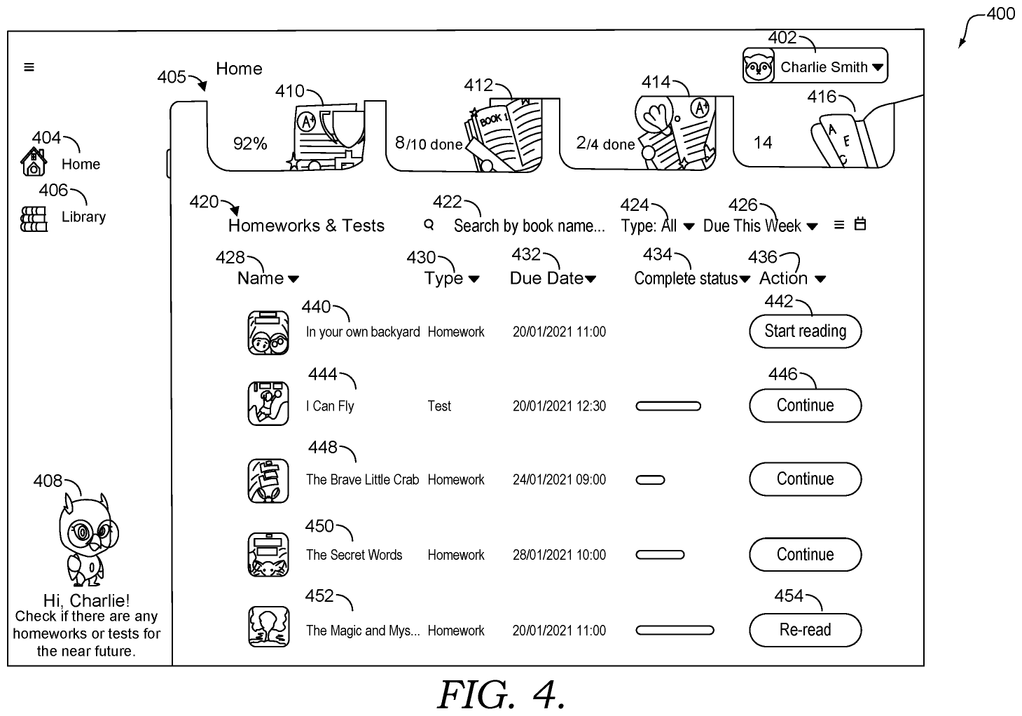

In one embodiment, the student is taken to an assignment-interface generated by the assignment interface component 312. The assignment interface may be similar to the assignment interface 400 described subsequently with reference to FIG. 4. The assignment interface may act as a homepage for the student. The assignment interface shows active assignments. The assignments could be complete, in progress, or not yet started. The assignments could be assigned by a parent or teacher. In aspects, students can select their own assignments by navigating to a library view. The library view may be provided by the library interface component 362. The library view allows the user to search the reading database 260 for reading assignments. Various search and filtering functions may be available to the student. The library view may also be accessed by parents and teachers through the teacher interface 320 or the parent interface 330. Parents and teachers may assign a student a reading assignment through the library view.

The library interface 362 can also display recommendations generated by the recommendation system 360. The recommendations can be for books, reading assignments, games, and the like. The recommendation system 360 can take various factors into account when making a recommendation. These factors may be retrieved from a student profile 352. The factors can include survey data provided by a student. The survey data can include an interest survey. The genres of interest to particular student can be learned through the interest survey. The factors can also include a reading level appropriate for the student. The reading level appropriate for the student can be calculated periodically and updated to match the student's increased reading level as progress is made. The recommendations can be viewed by the student, teacher, or parent. In the case of the teacher or parent, the recommendation will be for a student.

The recommendation engine 360 can also generate a recommendation based on specific reading performance data for individual student. The performance data can indicate word groups or grammar that the student needs to practice. In addition to word groups, the recommendation system 360 can generate recommendations based on sounds (e.g., phonems) the student needs to practice pronouncing. The sounds can be identified by looking at a confidence score assigned by a speech-to-text converter when processing the audio recording of the student reading. In the case of the word groups or sounds, reassignments may be recommended that emphasize the desired word groups and sounds.

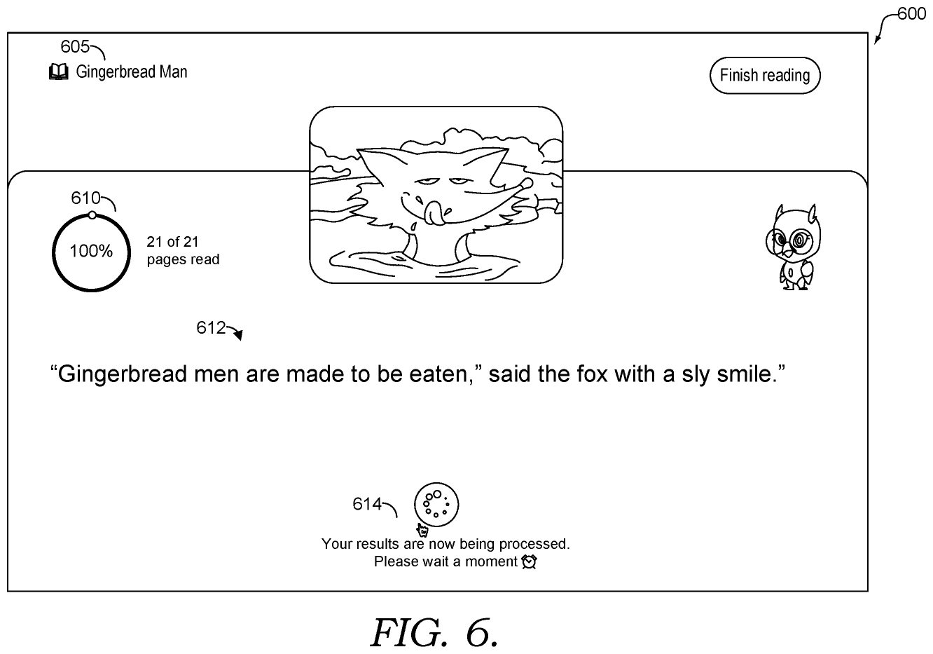

The assignment interface component 312 can provide a link to a reading interface generated by the reading-reception interface component 340. The reading interface presents a text to be read and captures an audio recording of the student reading the text. An example reading interface is described subsequently with reference to FIG. 6. After completing a reading assignment, the student can view a reading-performance interface generated by the result-output interface component 342. The reading-performance interface can display specific errors made when a specific student reads a specific text. The reading performance interface can also allow the student to listen to an audio recording of the student's reading effort.

The arcade game interface 314 provides an interface through which arcade games may be played using reward points earned by completing reading assignments. As used herein, access to the arcade games in the arcade game interface 314 may be limited by time and other factors. In a point system, points earned by completing assignment may be associated with the student profile 352. The arcade game interface 314 may determine whether a given student has enough reward points to play game. Upon playing a game for a designated amount of time, the arcade game interface 314 may deduct points a corresponding amount of reward points from the student's reward account.

The phonetic game interface component 316 generates phonetic games for the user to play. In one example, the phonetic game includes a picture of an entity, such as a cat. The user then attempts to spell cat to win the game. As an alternative game mode to spelling cat, the student may simply pronounce the word cat. The phonetic game interface component 316 generates games that encourage the user to pronounce different sounds.

The teacher interface 320 gives a teacher access to resources within the reading instruction system. An identification associated with an individual teacher can be used to manage access to various resources, such as class and student records. The teacher profile 354 can associate the teacher to a class, which is in turn associated with student identifications for students in the class. The teacher profile 354 can also associate the teacher with individual students. These relationships are used to give the teacher access to reading assignments and other information associated with students in his/her class. The teacher view component 322 generates a teacher view, which may be similar to the teacher view 1100 described subsequently. The teacher view can provide a dashboard that displays reading statistics for the entire class. The teacher view can also provide reading data for individual students. The teacher view can also allow a teacher to assign new reading assignments to a student and/or class. The teacher view can serve as a homepage for teachers. The teacher can view a reading-performance interface generated by the result-output interface component 342. The reading-performance interface can display specific errors made when a specific student reads a specific text. The reading performance interface can also allow the teacher to listen to an audio recording of the student's reading effort.

The teacher interface 320 includes an error-approval interface component 324 that allows a teacher to approve or deny error suggestions made by teachers and students. If the teacher agrees that the classifier made a mistake, the mistake can be corrected through the error approval interface 324. A misclassification record is created and can be used to change a proficiency score assigned based on the reading assignment. The misclassification record can also be used as training data to tune an error classifier.

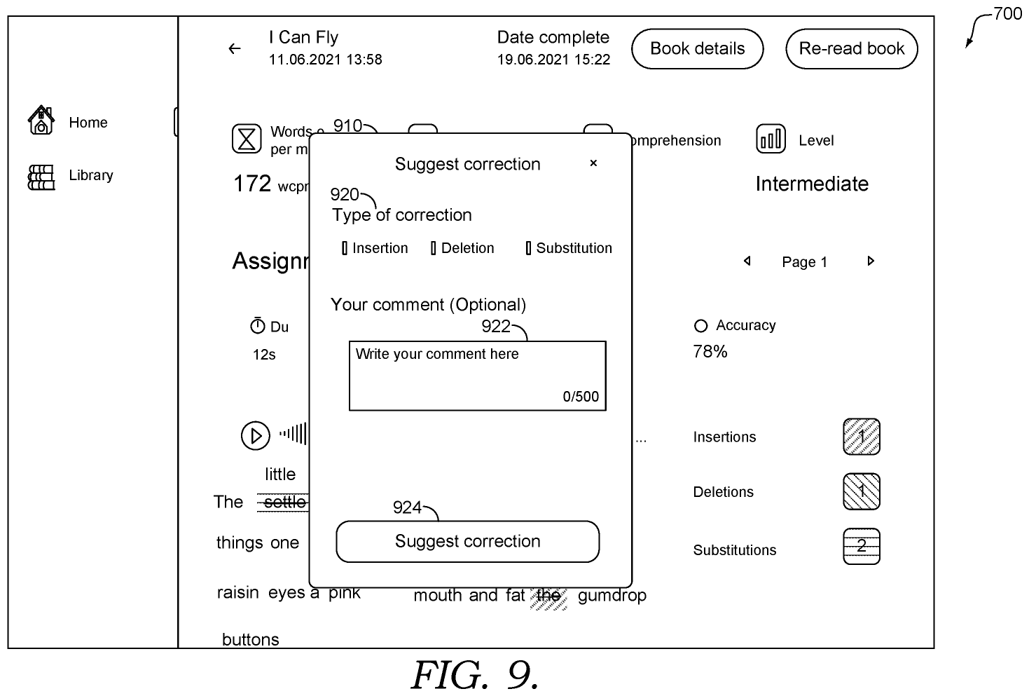

The parent interface component 330 gives parent's access to their students reading assignments and performance metrics. A parent profile 356 may be used to associate a parent with one or more students. Once associated with a student, the parent may view information associated with the student. The parent view 332 can provide a view that is very similar to the student's assignment interface described in FIG. 4. The parent can view a reading-performance interface generated by the result-output interface component 342. The reading-performance interface can display specific errors made when a specific student reads a specific text. The reading performance interface can also allow the parent to listen to an audio recording of the student's reading effort. If a parent believes that the error is a result of a misclassification, then the error suggestion interface generated by the error identification component 334 allows the parent to submit a suggestion to the teacher that a misclassification occurred. The teacher can then accept or deny this suggestion through the error approval interface 324. An error suggestion interface is described subsequently with reference to FIG. 9.

Turning now to FIG. 4, a diagram depicting an assignment interface 400 suitable for implementing aspects of the present disclosure is provided. The assignment interface 400 shows assignments associated with a particular student. The assignment interface 400 may be accessed by a various users including a particular student, a teacher, or parent. A user, such as a teacher or parent, with access to multiple student records may select a student through the student selection interface 402. In aspects, a student may only be given access to their own assignments. The student selection interface 402 may simply display the student's name in the student view. In the parent-teacher view, the student selection interface 402 may allow a teacher to access the assignments associated with a student in the teacher's class. The student selection interface 402 may allow a parent to switch between the records of two or more children.

To the left of the assignment interface 400 are a home control 404 and a library control 406. The home view is shown. The library control 406 will take the user to a library of available books. Students may select books from the library to add to their assignments. Teachers and parents may assign books to a student. Though not shown, the library view can allow users to sort books by name, type, author, reading level, genre, and other characteristics.

The personal assistant 408 communicates a message to the user. In this case, the message reminds the user to check back for homework. The personal assistant 408 may communicate messages selected based on a heuristic. For example, a message could be selected to highlight an assignment the user should view. For example, recently completed assignments may be highlighted to teachers and parents. The highlighting can remind the teachers and parents to review a detailed record of the student's reading performance. A message could help a student achieve a reading goal, such as reading 50 pages per week. In this example, the personal assistant could select an existing assignment that would cause the student to complete his or her goal upon completing the existing assignment. Various heuristics can be used to generate appropriate messages.

Near the top of the assignment will interface 400, a progress-overview section 405 is provided. The progress-overview section 405 and overall reading accuracy score 410, a book progress indicator 412, test progress indicator 414, and a book completion record 416. The overall reading accuracy score 410 combines an accuracy score assigned to various completed reading homework to provide an overall score. In an embodiment, the overall score is based on a threshold number of the most recently read books, such as the last ten books. Alternatively, the score could be based on books read within a threshold period, such as the last month or year. In aspects, the overall score is an average of all scores in the calculation. In another aspect, the overall score is a weighted average, which favors the more recently completed reading assignments.

The book progress indicator 412 communicates how many assigned books have been read and how many assigned books are left to read. The test progress indicator 414 communicates how many assigned tests have been taken and how many assigned tests remain to be taken. The book completion record 416 communicates how e-books have been read by the student.

Various controls are provided for customizing the assigned homework and tests shown in the home works and tests section 420. The search bar 422 allows the user to search for a book by name. The type selector 424 allows a user to select a type of assignment to be displayed. In this example, the type selector 424 allows a user to select either homework or tests. The date due control 426 allows the user to filter based on due date of an assignment. In this example, only assignments due this week are shown. The name sort control 428 allows the user to alphabetically sort assignments based on a book name. The type sort control 430 allows the assignments to be sorted by type. The due date sort control 432 allows the user to sort the assignments chronologically by due date. The completion-status sort control 434 allows the user to sort assignments based on completion status. The completion status can include not started, finished, and in progress. In one embodiment, the degree of completion is indicated by a color. Red may indicate that the reading assignment is less than 25% complete, or may indicate that the reading assignment is between 26% and 75% complete, green may indicate that the reading assignment is more than 75% complete. In addition to a color, the size of the completion bar may be proportionally sized to the reading progress. The action sort control 436 allows the user to sort the assignments based on an associated action, such as start reading 442, continue 446, and re-read 454.

Five assignments are shown. The first assignment 440 is a homework assignment that the student has not started. The user can start the assignment by selecting the start reading 442 action control. The second assignment 444 is a test that is in progress. The student may continue the test by selecting the continue 446 action control. The third assignment 448 is a homework assignment that is in progress. The fourth assignment 450 is a homework assignment that is in progress. The fifth assignment 452 is a homework assignment that has been completed.

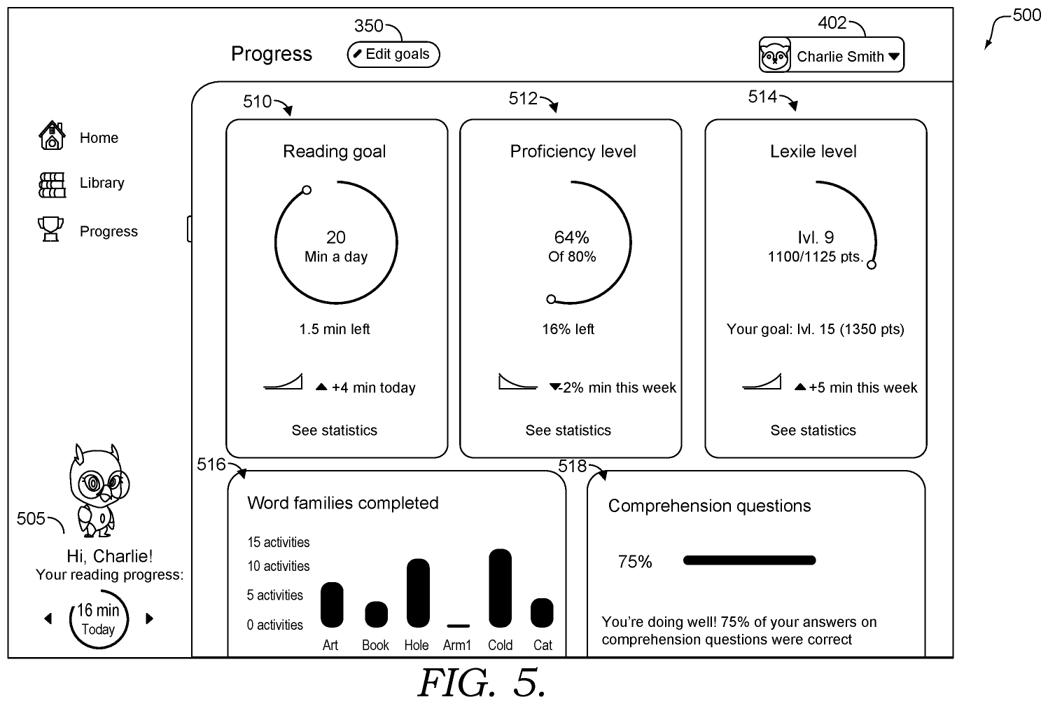

Turning now to FIG. 5, a diagram depicting a reading-progress interface 500 suitable for implementing aspects of the present disclosure is provided. The reading-progress interface 500 shows reading progress statistics for a particular student. The reading-progress interface 500 may be accessed by a various users including a particular student, a teacher, or parent. A user, such as a teacher or parent, with access to multiple student records may select a student through the student selection interface 402. In aspects, a student may only be given access to their own assignments. The student selection interface 402 may simply display the student's name in the student view. In the parent-teacher view, the student selection interface 402 may allow a teacher to access the assignments associated with a student in the teacher's class. The student selection interface 402 may allow a parent to switch between the records of two or more children. The personal assistant 505 provides a message encouraging the student to make more reading progress.

The reading-progress interface 500 includes a reading-goal progress interface 510. The reading-goal progress interface 510 visually depicts a student's progress towards completing a daily reading goal. In the example, the reading goal is 20 minutes and the student needs to read for another minute and a half to achieve the 20-minute goal. The progress made towards achieving a goal is indicated textually (e.g., 90%) and with a timer display. The reading-goal progress interface 510 also includes a trend line showing the time a student spends reading daily. The trend line can be color-coded to indicate whether the trend is improving, staying the same, or decreasing. Green may be associated with an increasing trend. Red may be associated with a decreasing trend. Orange may be associated with a level trend. The reading-goal progress interface 510 includes a control that allows a detailed view of the reading statistics for the student. The detailed view could show each book read over a period along with the time spent per day on each book.

The reading-progress interface 500 includes a reading-proficiency interface 512. The reading-proficiency interface 512 provides a proficiency score achieved for reading assignments within a plurality of assignments used to calculate the proficiency level. The plurality of books could be selected based on a time period, such as a day, week, two weeks, month, or year. Other customized time periods are possible. In this example, the reading proficiency level is 64% and the goal for the student is 80%. Alternatively, the proficiency score could be based on the last threshold number of reading assignments, such as the last ten assignments. A trend line shows that the reading proficiency level achieved by the student has been decreasing. The trend line could be based on a daily proficiency score calculated for the student. The trend line can be color-coded to indicate whether the trend is improving, staying the same, or decreasing. Green may be associated with an increasing trend. Red may be associated with a decreasing trend. Orange may be associated with a level trend. The reading-proficiency interface 512 includes a control that allows a detailed view of the reading statistics for the student. The detailed view could show each reading assignment completed or attempted over a time period along with a proficiency calculated for the reading assignments.

The reading-progress interface 500 includes a Lexile-level interface 512. The Lexile Framework for Reading is an educational tool that uses a measure called a Lexile to match readers with books, articles and other leveled reading resources. Readers and books are assigned a score on the Lexile scale, in which lower scores reflect easier readability for books and lower reading ability for readers. The Lexile framework uses quantitative methods, based on individual words and sentence lengths, rather than qualitative analysis of content to produce scores.

The Lexile-level interface 514 provides a Lexile level achieved for reading assignments within a plurality of assignments used to calculate the Lexile level. The plurality of books could be selected based on a time period, such as a day, week, two weeks, month, or year. Other customized time periods are possible. Alternatively, the Lexile score could be based on the last threshold number of reading assignments, such as the last ten assignments. In this example, the reading Lexile level is level 9 (1100/1125 points) and the goal for the student is level 15. A trend line shows that the Lexile level achieved by the student has been increasing. The trend line could be based on a daily Lexile score calculated for the student. The trend line can be color-coded to indicate whether the trend is improving, staying the same, or decreasing. Green may be associated with an increasing trend. Red may be associated with a decreasing trend. Orange may be associated with a level trend. The Lexile-level interface 514 includes a control that allows a detailed view of the reading statistics for the student. The detailed view could show each reading assignment completed or attempted over a time period along with a Lexile level calculated for the reading assignments.

The reading-progress interface 500 includes a word family interface 516. The word family interface 516 shows the number of assignments the student has completed that emphasize a particular word family. The reading-progress interface 500 includes a comprehension question interface 518. The comprehension question interface 518 displays an average comprehension measure indicating how the student has been doing on recent comprehension tests. A comprehension test measures a reader's understanding of a reading assignment. The recent comprehension tests could be selected based on a time period, such as a day, week, two weeks, month, or year. Other customized time periods are possible. Alternatively, the average comprehension measure could be based on the last threshold number of reading assignments, such as the last ten assignments.

Turning now to FIG. 6, a diagram depicting a reading interface 600 suitable for implementing aspects of the present disclosure is provided. The reading interface 600 is used by students to complete a reading assignment. The reading interface 600 outputs at text 612 to be read by a student. The student reads the text 612 aloud. The sound made by student's reading is captured by a microphone associated with the computing device. The computing device uses the captured sound to generate an audio recording of the student reading. The portion of the recording corresponding to a specific text is tracked. For example, the text 612 could be associated with a time frame within the audio recording. A record is created that correlates the audio recording with various text read by the student. The correlation record enables the student's reading effort to be compared to the text 612 for accuracy.

The reading interface 600 includes a title the book 605 from which the reading assignment is derived. A reading assignment may be an entire book, a chapter of a book, multiple chapters of the book, a page range, or some other designated portion of the book. The reassignment could also be a short story, news article, or the like. The progress tracker 610 communicates to the student progress made during the reassignment. The progress tracker 610 shown indicates that the assignment has been finished. The audio processing guide 614 communicates that the proficiency score and error record is being generated for the completed reading assignment. Upon completion, a reading-analysis interface 700 may be presented.

Turning now to FIG. 7, a diagram depicting a reading-analysis interface 700 suitable for implementing aspects of the present disclosure is provided. The reading-analysis interface 700 provides a detailed analysis of an individual reading assignment. At the top, the reading-analysis interface 700 a title the book 702 from which the reading assignment was drawn, a date 704 the reading assignment was completed, a book details control 706, and a rereading control 708. Selecting the rereading control 708 will allow the student to restart the assignment. Selection of the book details control 706 will cause additional details about the book, such as reading level, length, author, genre, publication date, and the like, to be provided.

The homework analysis section 716 includes a page control 718. The page control 718 allows a user to navigate from page-to-page of the reading assignment. The text on a single page of the homework analysis interface may correspond to the text presented on a single page of the reading interface 600.

The audio interface 719 includes an audio control 722 and audio progress tracker 720. The audio control 722 allows a recording of the student reading the text 730 to be output to speakers or headphones. The audio progress tracker 720 communicates what part of the recording being output.

The homework analysis section 716 explains each error made by the student while reading the text 703 on the page being displayed. An insertion error 724 is a word added that is not in the text. A deletion 726 is a word that is in the text but not pronounced in the audio recording of the students reading effort. A substitution 728 occurs when the student replaces a first word in the text with a second word that is not in the text. Each of the explanations may be associated with a color. The color you may be used to point out errors of each type within the text. For example, a substitution can be associated with blue and the first error 732 also be shown in blue. The first error 732 is a substitution because the student read settle, which is not in the text, instead of little. The second error 734 is deletion because the student left out the letter a. The third error 736 is a substitution because the student spoke “hat” instead of “had.” The fourth error 738 is an insertion because the user read “the” when “the” is not in the text.

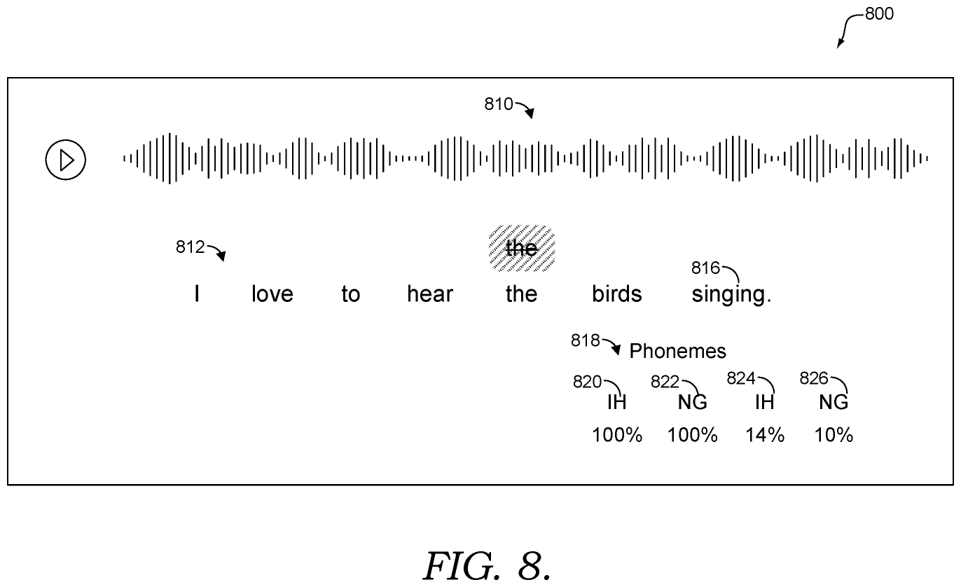

Turning now to FIG. 8, a diagram depicting a phonemes-analysis interface 800 suitable for implementing aspects of the present disclosure is provided. The phonemes-analysis interface 800 may be open by clicking on a word 816 within the text 812 displayed in the homework analysis section 716 or other interface. The phonemes-analysis interface 800 includes an audio interface to allow a student, teacher, and/or parent to listen to a recording of the student reading. The phonemes detail view 818 shows the phonemes identified within the audio recording of the user reading. In this case, the phoneme “IH” 820 was identified with a 100% confidence score, the phoneme “NG” 822, was identified with a 100% confidence, the phoneme “IH” was identified with only and 14% confidence, and the phoneme “NG” was identified with only a 10% confidence. This indicates that the student may have said “sing” or “singing.” The phoneme detail view 818 can help a student, teacher, or parent understand how the student mispronounced a word. The phoneme detail view 818 can also help identify phonemes the student is struggling to pronounce. These identified phonemes can be used by the recommendation system 360 to identify reading assignments that include these phonemes and help the student practice and ultimately master the phonemes.

Turning now to FIG. 9, a diagram depicting an error-correction interface 910 suitable for implementing aspects of the present disclosure is provided. The error-correction interface 910 allows a user to designate a classification made by the error-identifier 220 as incorrect. The designation can specify that a word spoken by a student during a reading assignment was incorrectly classified as an error. Conversely, the designation can specify that a word spoken by a student during a reading assignment was incorrectly classified as correct and should have been recognized as an error. The error-correction interface 910 may be accessed from the reading-analysis interface 700. In one embodiment, the user is able to left click on a word to open the error-correction interface 910. The clicked-upon word may then be automatically associated with an misclassification record generated through user input. The error-correction interface 910 allows the user to select the error type to be associated with the word through the type selection interface 920. The user can make comments explaining why they think a correction is needed. The misclassification record can be created by selecting the suggested correction button 924. If a student or parent initiates the suggestion, then a notification may be provided to a teacher of the student. The teacher can then review the suggestion and either accept or reject the suggestion. A teacher may be able to generate a misclassification record without approval of others.

The misclassification record may be used for retraining a classifier, such as the one or more classifiers associated with the error identifier 220. The misclassification record can be used to generate supplemental training data that may be used to improve the classification accuracy. In an aspect, the misclassification record is used to generate a student-specific version of a classifier. This type of training may be described as tuning the classifier. A misclassification record may be used to generate training data that includes an audio of the student reading along with the correct classification as a training label. As an alternative to or in addition to the student-specific training, misclassification records may be aggregated and used for general retraining.

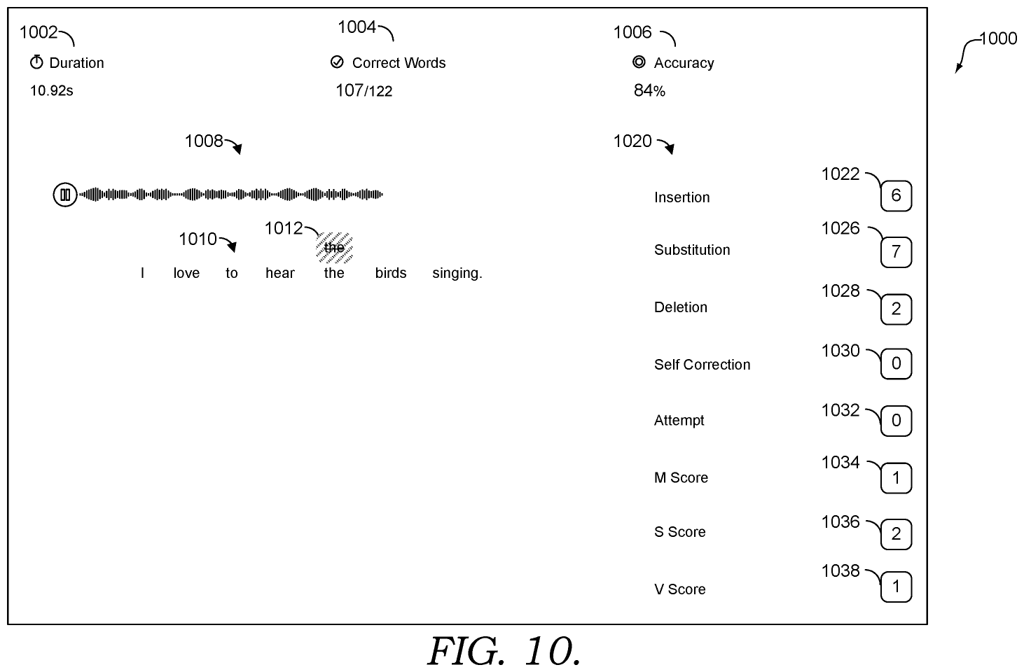

Turning now to FIG. 10, a diagram depicting an error-type analysis interface 1000 suitable for implementing aspects of the present disclosure is provided. The error-type analysis interface 1000 provides an overview of the error types made during a reading assignment. In one embodiment, a user may select an error types such as insertion selector 1022, to navigate to the next insertion error made in the reading assignment. In this way, the user may navigate between instances of an error of a particular type. The error type selector may also indicate how many errors of the particular type, if any, were made in the reading assignment. The error-type analysis interface 1000 includes a substitution selector 1026, deletion selector 1028, self-correction selector 1030, attempts selector 1032, M score selector 1034, S score selector 1036, and V score selector 1038. Upon selecting a selector, such as the deletion selector 1028, the user is navigated to text 1010 in which the deletion error 1012 occurred. The error-type analysis interface 1000 shows the duration 1002 of an audio clip associated with the text 1010 being displayed. A correct word interface 1004, communicates how many of the total words in the reading assignment the student pronounce correctly. The accuracy interface 1006 communicates accuracy score for the reading assignment.

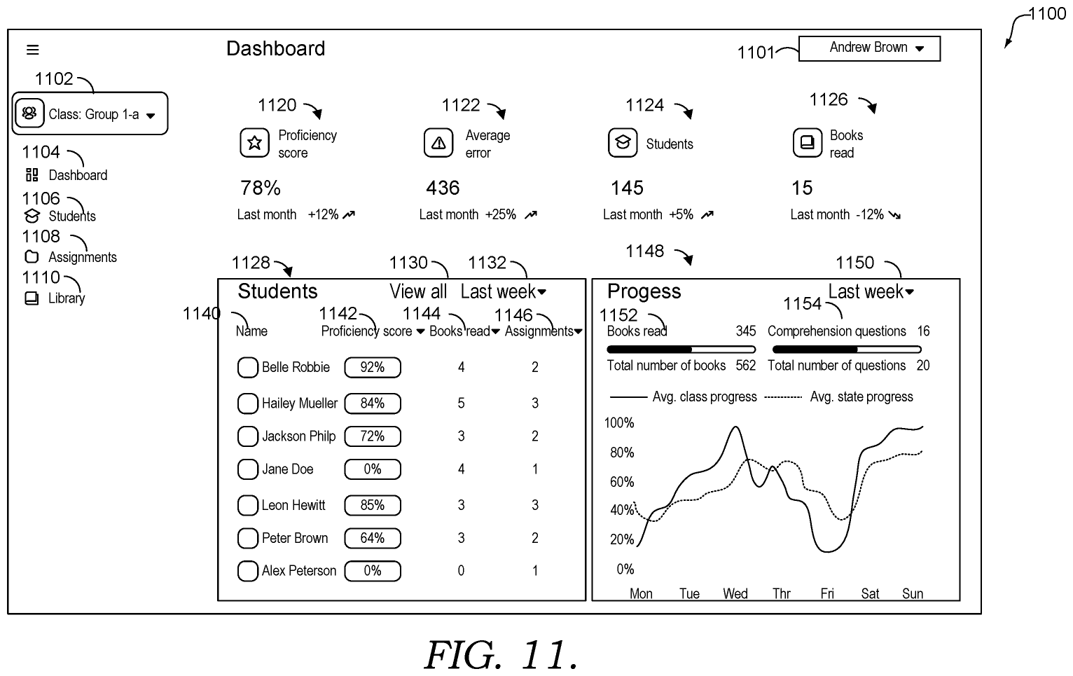

Turning now to FIG. 11, a diagram depicting a teacher interface 1100 suitable for implementing aspects of the present disclosure is provided. The teacher interface 11,000 may serve as a teacher homepage. The teacher interface 1100 provides class progress for a teacher and allows the teacher to view a reading progress interface for each student in class. The class selection interface 1102 allows the teacher to select a class to view. To the left of the teacher interface 1100, are controls that allow the teacher to navigate directly to the dashboard view 1104, the student view 1106, the assignment view 1108, or the library view 1110. The library view allows a teacher to search for books and/or reading assignments to assigned individual students or a class. Upon selection of a reading assignment for a student and/or class, the reading assignment will appear as an assignment associated with the student or each student in the class, such as described previously with reference to FIG. 4.

The teacher selection control 1101 displays a teacher's name. Users with administrative privileges, such as a principal, may use the teacher selection control 1101 to select a teacher. A teacher may only have access their classes and students. The dashboard includes a class proficiency score 1120, and average error score 1022, total students 1124, and books read 1126 during a time. Each dashboard widget may include a trend line. The trend line can be color-coded to indicate whether the trend is improving, staying the same, or decreasing. Green may be associated with an increasing trend. Red may be associated with a decreasing trend. Orange may be associated with a level trend.

The student view 1128 shows information for students in a selected classroom. They view selector 1130 is set to view all students. However, various criteria may be used to display a subset of students, such as those with a particular reading level, progress score, or the like. The time control 1132 designates a period of time for which statistics are gathered, such as a week. In a first column 1140, student names are displayed. In a second column 1142, a proficiency score associated with each student is displayed. In a third column 1144, an amount of books read during the time period is displayed. In a fourth column 1146, an amount of assignments completed during the time period is displayed. The progress section 1148 shows progress made during a time period, such as a week, selected with the range control 1150. The progress section includes a book completion interface 1152 that displays a total number of books read in the class and the total books assigned. The comprehension interface 1154 shows the total comprehension questions answered correctly and questions asked.

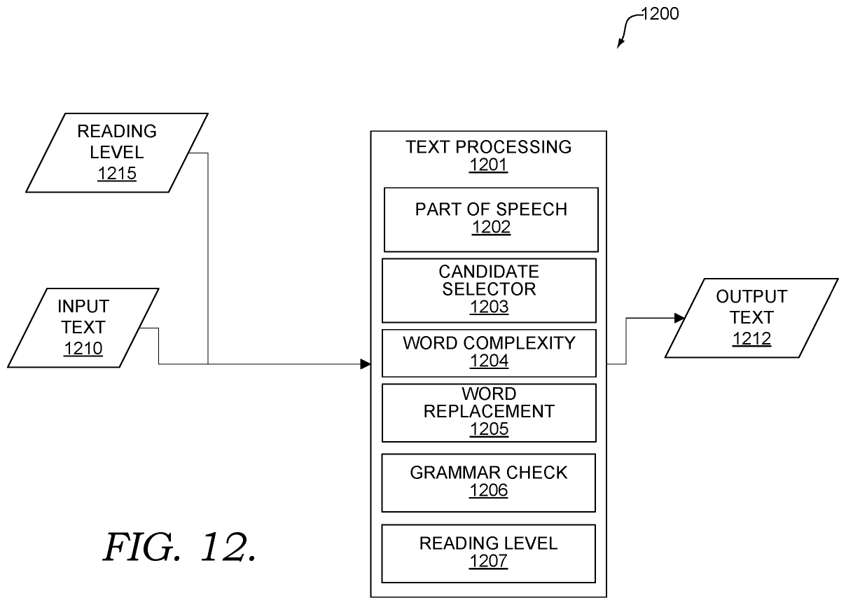

Referring now to FIG. 12, with FIGS. 1 and 2, a block diagram is provided showing aspects of an example computing system architecture suitable for implementing some aspects of the present disclosure and designated generally as reading-level adjustment system 1200. Reading evaluation system 1200 represents only one example of a suitable computing system architecture. Other arrangements and elements may be used in addition to or instead of those shown, and some elements may be omitted altogether for the sake of clarity. Further, as with operating environment 100, many of the elements described herein are functional entities that may be implemented as discrete or distributed components or in conjunction with other components, and in any suitable combination and location.

Example reading-level adjustment system 1200 includes text processing system (and its components 1201, 1202, 1203, 1204, 1205, 1206, and 1207). These components may be embodied as a set of compiled computer instructions or functions, program modules, computer software services, or an arrangement of processes carried out on one or more computer systems, such as computing device 1600 described in connection to FIG. 16, for example. The components can use one or more application program interfaces (API) to communicate with each other. The APIs may allow the components to communicate with programs and program components not shown in FIG. 2 or FIG. 12.

In one aspect, the functions performed by components of reading-level adjustment system 1200 are associated with one or more applications, services, or routines. In particular, such applications, services, or routines may operate on one or more user devices (such as user device 102a), servers (such as server 106), may be distributed across one or more user devices and servers, or be implemented in the cloud. Moreover, in some aspects, these components of reading-level adjustment system 1200 may be distributed across a network, including one or more servers (such as server 106) and client devices (such as user device 102a), in the cloud, or may reside on a user device, such as user device 102a. Moreover, these components, functions performed by these components, or services carried out by these components may be implemented at appropriate abstraction layer(s), such as the operating system layer, application layer, hardware layer, etc., of the computing system(s). Alternatively, or in addition, the functionality of these components and/or the aspects described herein may be performed, at least in part, by one or more hardware logic components. For example, and without limitation, illustrative types of hardware logic components that may be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with reference to specific components shown in example reading-level adjustment system 1200, it is contemplated that in some aspects functionality of these components may be shared or distributed across other components.

At a high level, the text processor 1210 receives an input text 1210, receives a desired reading level 1215, and generates an output text 1212 with the desired reading level. TABLE 2 provides an example of how the text processor 1201 would take an input text 1210 and provide a complexified result as the output text 1212. The text processor 1201 takes the original sentence and looks for more complex synonyms, providing an enhanced result by converting ‘dog’ to ‘canine’, ‘ate’ to ‘consumed’, and ‘food’ to ‘meal’. In the second result, an even more complexified sentence is generated where ‘meal’ is enhanced to ‘repast’. Finally, an example semantic error that the text processor 1201 avoids through semantic analysis is provided. In the last result, the system mistakenly sees ‘bowl’ as meaning ‘bowling’ and attempts to suggest an unsuitable synonym for ‘bowling’ of ‘kegling’. The parts of speech component 1202, grammar check component 1206 and other parts of the text processor 1201 work together to prevent semantic errors. For example, the error might be prevented by first classifying bowl as a noun, rather than a verb.

TABLE 2

| | |
|---|---|
| Original Sentence | The dog ate his food from the bowl. |
| Complexified Sentence | The canine consumed his meal from the bowl. |
| Advanced Complexified | The canine consumed his repast from the bowl. |
| Sentence | |
| Complexified Sentence | The canine consumed his repast from the |
| with Semantic Error | kegling. |

The text processor 1201 comprises a part of speech component 1202, a candidate selector 1203, and word complexity component 1204, and word replacement component 1205, a grammar check component 1206 and a reading-level component 1207. The text processor 1201 receives and input text 1210 and a desired reading level 1215.

The input text 1210 may be a book, news article, blog post, short story, or any other textual content. The input text 1210 may be provided in electronic format, such as in a PDF format, WORD format, HTML, and the like. If the input text 1210 is received in a tangible format, such printed on paper, then the input text 1210 may be scanned and converted to editable text via an optical character recognition process.

An initial reading level of the textual content may be determined by the reading level component 1207. Alternatively, the reading level of the text may be provided with the input text 1210. For example, the reading level may be meta data associated with a text file. The reading level of the input text 1210 could also be specified through a user interface.

A desired reading level 1215 for the output text 1212 is received. The desired reading level 1215 may be based on a reading level determined for a reader. In one aspect, the reading level for a reader may be the MSV score 258. The MSV score 258 may be mapped to a reading level schema to enable use of the MSV score 258 for selecting the desired reading level. The desired reading level may be set one or two increments above the reading level equivalent to the MSV score 258.

The desired reading level 215 may be provided through a user interface that provides selectable reading levels. For example, the selectable reading levels for a text could be 7.1, 7.2, 7.3, 7.4, and so on. These example-reading levels increase the 7^{th} grade reading level by 10% of the 8^{th} grade reading level incrementally. In other words, 7.1 is not necessarily 10% more difficult than the 7^{th} grade reading level, but 10% of the difficulty difference between the 7^{th} and 8^{th} grade reading levels. The reading levels used by the technology described herein can use existing reading level measurements, such as, but not limited to, GUIDED READING LEVELS (GRL), ACCELERATED READER (AR) ATOS LEVEL, DEVELOPMENTAL READING ASSESSMENT (DRA), and LEXILE MEASUREMENT.

The part of speech component 1202 takes as an input the input text 1210 and a list of parts of speech for potential target words and generates a list of target words for potential replacement. For example, the parts of speech maybe nouns, adjectives, and verbs. The speech component 1202 uses a part-of-speech (POS) tagging algorithm in order to tag each word in a text and choose the target ones for replacement. For example, all nouns, verbs, and adjectives in the text may be tagged for potential replacement. The (POS) tagging algorithm may tokenize the input text and then process it with a natural language processing model trained to classify words into a grammatical class. The NLP model may be trained on a large corpus of labeled training data. The training data will have a sentence (or other phrase) with each word assigned to the ground-truth grammatical category by a person. In this way, the NLP technology can be used to classify words in unlabeled text, such as the input text 1212. In an aspect, a confidence score may be assigned to each word indicating a strength of classification. If the confidence score falls below a threshold, then the corresponding word may be excluded for consideration as a target for replacement. Using the threshold may prevent the generation of grammatically incorrect replacement texts.

The candidate selector 1203 takes the list of target words from the speech component 1202 and identifies synonyms. The synonyms may be selected from multiple sources, such as BERT, Wordnet lexical base, Merriam Webster thesaurus, and like. The synonyms may be limited to the same part of speech assigned to the target word. When multiple sources are used a de-duplication or other process may be used to ensure a synonym is added to the candidate word list only a single time.

The word complexity component 1204 assigns a complexity score to each candidate word. The complexity may be retrieved from one or more sources, such as, but not limited to Fog readability formula, simplified Flesch-Kincaid grade level readability formula, Sander's consonant acquisition chart, word frequency, Flesch-Kincaid grade level Readability Formula, and the like. In one aspect, complexity score from multiple sources are normalized and then combined through a weighting algorithm. Giving equal weight to various sources is possible or differential weights may be used.

The word replacement component 1205 takes as an input the target words from the part of speech component 1202 and their candidate replacements from the candidate selector 1203 along with their complexity scores (obtained by means of the word complexity component 1204). The word replacement component 1205 replaces target words with their synonyms and inflects them to the right grammatical form. This produces a candidate replacement text. The complexity level is used to select words to substitute with words in the input text 1212. Initially, a heuristic may be used to select the complexity of candidate words and an amount of candidate words to substitute. The heuristic may map various candidate words to a reading level adjustment that will result with each word, given an initial reading level of the text. The heuristic may also exclude candidate words with above a threshold complexity for use with certain desired reading levels. This prevents inappropriately complex words from being used as substitute words.

Once the candidate words are selected based on the assigned complexity level, a candidate replacement text is generated by substituting one or more target words in the textual content with one or more candidate replacement words. Not all target words originally identified need to be replaced.

As an additional quality check, an updated reading level for the candidate replacement text may be determined by the reading-level component 1207. If the updated reading level is within a threshold of the desired reading level, then the candidate replacement text may be output to the user. If outside the threshold, then the candidate replacement text may be adjusted by undoing a replacement, making a new replacement, or updating a replacement with more complex or less complex candidate word.

The grammar check component 1206 looks for grammar errors within a text. A grammar check may be run on the candidate replacement text and grammatical changes made as needed. Alternatively, a candidate replacement text with a grammatical problem may be rejected completely, or in part, and a new candidate replacement text generated. The new candidate replacement text may be generated with a limitation that prevents substitution with one or more candidate words associated with a portion of text with an identified grammatical problem.

A grammar checker, in computing terms, is a program, or part of a program, that attempts to verify written text for grammatical correctness. A grammar checker will find each sentence in a text, look up each word in the dictionary, and then attempt to parse the sentence into a form that matches a grammar. Using various rules, the program can then detect various errors, such as agreement in tense, number, word order, and so on. It is also possible to detect some stylistic problems with the text. For example, some popular style guides such as The Elements of Style deprecate excessive use of the passive voice. Grammar checkers may attempt to identify passive sentences and suggest an active-voice alternative. Various grammar models can be used including binary and probabilistic models. A binary model assigns a yes/no score, while a probabilistic model assigns a probability that the grammar is correct. When discussing grammar and grammar models, the following term definitions may be used.

Grammar: In natural language, grammar is a set of rules restricting which kinds of words can appear in which places within a sentence, phrase, or other language unit. Almost all theoretical grammar models describe sentences as having tree structures.

Constituency: “Constituency” refers to the ability of a phrase to function as a single unit. Phrases which exhibit constituency are the “constituents” of a sentence. “Mary fell off the bench” has the non-trivial constituents: “the bench,” “off the bench,” “fell off the bench”. (Each word, and the entire sentence, are also constituents.)

Generative Grammar Model: “Generative” refers to the notion that sentence structures can be generated from phrase structure rules (PSRs). The generative grammar model produces a binary decision about correct grammar. A binary yes/no decision is in contrast to a probabilistic model that determines a probability that a given usage is grammatical.

Phrase structure rule: A phrase structure rule has the form: X→AB. Aspects of the technology described herein can use phrase structure rules and generative syntax to build a grammar model. The “generative” in generative syntax refers to the notion that sentence structures can be generated from phrase structure rules (PSRs). A phrase structure rule has the form: X→AB. The phrase structure rule can correspond to a binary branching structure (the parent node X has the children A and B). In other words, the phrase X includes the constituents A and B.

The reading-level component 1207 assigns a reading level to a text. In one aspect, a reading-level system provided by Lexile is used to assign a reading level to a text. Use of other systems are possible.

Example Methods

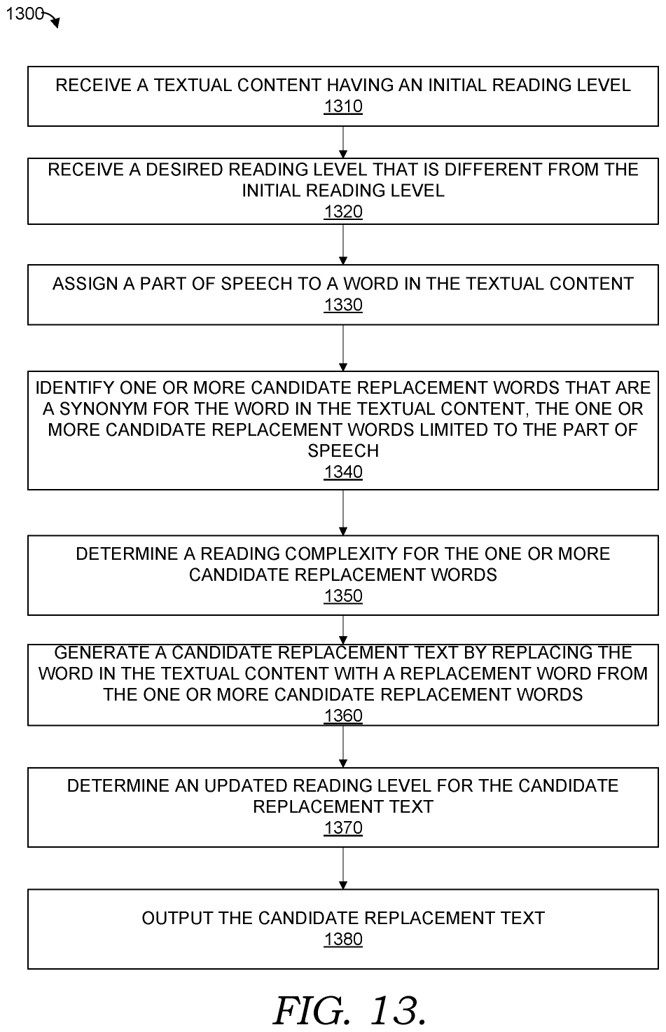

Now referring to FIGS. 13, 14 and 15, each block of methods 1300, 1400, and 1500, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The method may be provided by an operating system. In addition, methods 1300, 1400, and 1500 are described, by way of example, with respect to FIGS. 1-12. However, these methods may additionally or alternatively be executed by any one system, or any combination of systems, including, but not limited to, those described herein.

FIG. 13 is a flow diagram showing a method 1300 for adjusting a reading level of a text, in accordance with some embodiments of the present disclosure. Method 1300 could be performed on or with systems similar to those described with reference to FIGS. 1-12.

At step 1310, method 1300 includes receiving a textual content having an initial reading level. In aspects, the textual content is selected by a student, teacher, or parent, based on a student's reading interest. The initial reading level may be determined by analyzing the text. Alternatively, the initial reading level may be provided by a publisher of the text.

At step 1320, method 1300 includes receiving a desired reading level that is different from the initial reading level. The desired reading level may be based on a reader's current reading level. The desired reading level may be a threshold amount above the reader's current reading level. The current reading level may be based on an MSV score or other method.

At step 1330, method 1300 includes assigning a part of speech to a word in the textual content. At step 1340, method 1300 includes identifying one or more candidate replacement words that are a synonym for the word in the textual content, the one or more candidate replacement words limited to the part of speech. At step 1350, method 1300 includes determining a reading complexity for the one or more candidate replacement words.

At step 1360, method 1300 includes generating a candidate replacement text by replacing the word in the textual content with a replacement word from the one or more candidate replacement words. At step 1370, method 1300 includes determining an updated reading level for the candidate replacement text. At step 1380, method 1300 includes outputting the candidate replacement text.

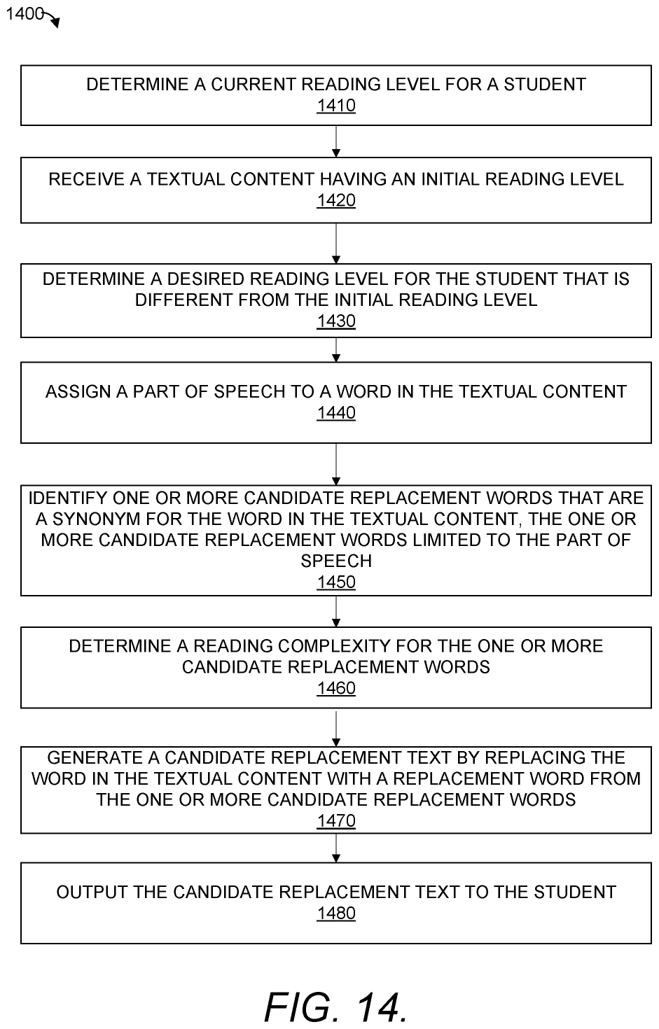

FIG. 14 is a flow diagram showing a method 1400 for adjusting a reading level of a text, in accordance with some embodiments of the present disclosure. Method 1400 could be performed on or with systems similar to those described with reference to FIGS. 1-12.

At step 1410, method 1400 includes determining a current reading level for a student. At step 1420, method 1400 includes receiving a textual content having an initial reading level. At step 1430, method 1400 includes determining a desired reading level for the student that is different from the initial reading level. At step 1440, method 1400 includes assigning a part of speech to a word in the textual content.

At step 1450, method 1400 includes identifying one or more candidate replacement words that are a synonym for the word in the textual content, the one or more candidate replacement words limited to the part of speech. At step 1460, method 1400 includes determining a reading complexity for the one or more candidate replacement words;

At step 1470, method 1400 includes generating a candidate replacement text by replacing the word in the textual content with a replacement word from the one or more candidate replacement words. At step 1480, method 1400 includes outputting the candidate replacement text to the student.

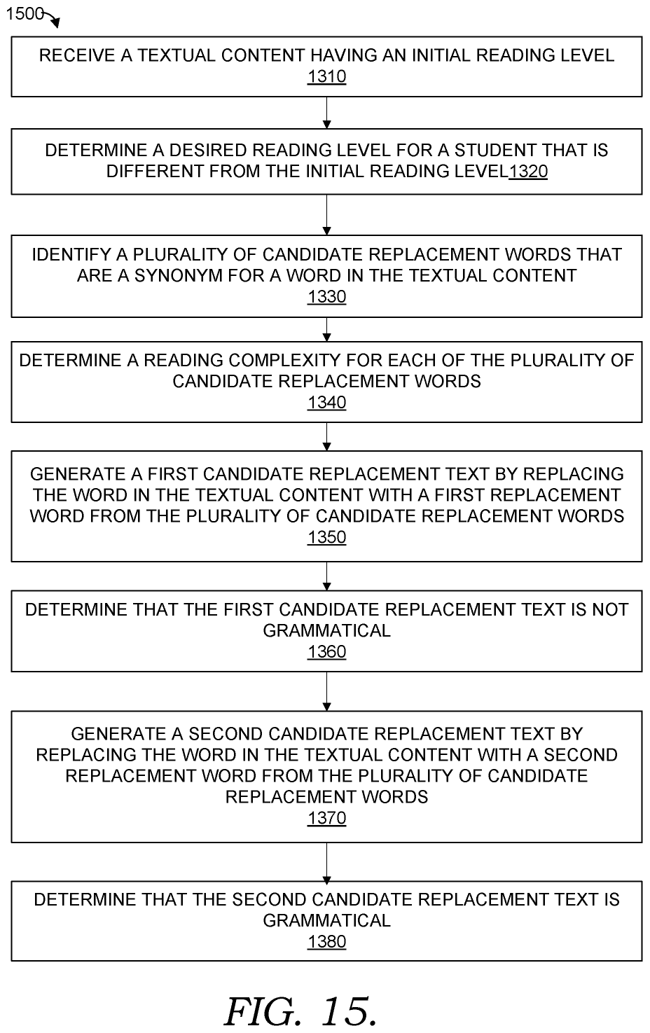

FIG. 15 is a flow diagram showing a method 1500 for adjusting a reading level of a text, in accordance with some embodiments of the present disclosure. Method 1500 could be performed on or with systems similar to those described with reference to FIGS. 1-12.

At step 1510, method 1500 includes receiving a textual content having an initial reading level. At step 1520, method 1500 includes determining a desired reading level for a student that is different from the initial reading level. At step 1530, method 1500 includes identifying a plurality of candidate replacement words that are a synonym for a word in the textual content.

At step 1540, method 1500 includes determining a reading complexity for each of the plurality of candidate replacement words.

At step 1550, method 1500 includes generating a first candidate replacement text by replacing the word in the textual content with a first replacement word from the plurality of candidate replacement words. At step 1560, method 1500 includes determining that the first candidate replacement text is not grammatical.

At step 1570, method 1500 includes generating a second candidate replacement text by replacing the word in the textual content with a second replacement word from the plurality of candidate replacement words. At step 1580, method 1500 includes determining that the second candidate replacement text is grammatical. At step 1590, method 1500 includes outputting the second candidate replacement text to the student.

Exemplary Operating Environment

Referring to the drawings in general, and initially to FIG. 16 in particular, an exemplary operating environment for implementing aspects of the technology described herein is shown and designated generally as computing device 1600. Computing device 1600 is but one example of a suitable computing environment and is not intended to suggest any limitation as to the scope of use of the technology described herein. Neither should the computing device 1600 be interpreted as having any dependency or requirement relating to any one or combination of components illustrated.

The technology described herein may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. The technology described herein may be practiced in a variety of system configurations, including handheld devices, consumer electronics, general-purpose computers, specialty computing devices, etc. Aspects of the technology described herein may also be practiced in distributed computing environments where tasks are performed by remote-processing devices that are linked through a communications network.

With continued reference to FIG. 16, computing device 1600 includes a bus 1610 that directly or indirectly couples the following devices: memory 1612, one or more processors 1614, one or more presentation components 1616, input/output (I/O) ports 318, I/O components 1620, and an illustrative power supply 1622. Bus 1610 represents what may be one or more busses (such as an address bus, data bus, or a combination thereof). Although the various blocks of FIG. 16 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art and reiterate that the diagram of FIG. 16 is merely illustrative of an exemplary computing device that may be used in connection with one or more aspects of the technology described herein. Distinction is not made between such categories as “workstation,” “server,” “laptop,” “handheld device,” etc., as all are contemplated within the scope of FIG. 16 and refer to “computer” or “computing device.”

Computing device 1600 typically includes a variety of computer-readable media. Computer-readable media may be any available media that may be accessed by computing device 1600 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 1612 includes computer storage media in the form of volatile and/or nonvolatile memory. The memory 1612 may be removable, non-removable, or a combination thereof. Exemplary memory includes solid-state memory, hard drives, optical-disc drives, etc. Computing device 1600 includes one or more processors 1614 that read data from various entities such as bus 1610, memory 1612, or I/O components 1620. Presentation component(s) 1616 present data indications to a user or other device. Exemplary presentation components 1616 include a display device, speaker, printing component, vibrating component, etc. I/O ports 1618 allow computing device 1600 to be logically coupled to other devices, including I/O components 1620, some of which may be built in.

Illustrative I/O components include a microphone, joystick, game pad, satellite dish, scanner, printer, display device, wireless device, a controller (such as a stylus, a keyboard, and a mouse), a natural user interface (NUI), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 1614 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may coexist with the display area of a display device, be integrated with the display device, or may exist as a separate device overlaying or otherwise appended to a display device. Any and all such variations, and any combination thereof, are contemplated to be within the scope of aspects of the technology described herein.

An NUI processes air gestures, voice, or other physiological inputs generated by a user. Appropriate NUI inputs may be interpreted as ink strokes for presentation in association with the computing device 1600. These requests may be transmitted to the appropriate network element for further processing. An NUI implements any combination of speech recognition, touch and stylus recognition, facial recognition, biometric recognition, gesture recognition both on screen and adjacent to the screen, air gestures, head and eye tracking, and touch recognition associated with displays on the computing device 1600. The computing device 1600 may be equipped with depth cameras, such as stereoscopic camera systems, infrared camera systems, RGB camera systems, and combinations of these, for gesture detection and recognition. Additionally, the computing device 1600 may be equipped with accelerometers or gyroscopes that enable detection of motion. The output of the accelerometers or gyroscopes may be provided to the display of the computing device 1600 to render immersive augmented reality or virtual reality.

A computing device may include a radio 1624. The radio 1624 transmits and receives radio communications. The computing device may be a wireless terminal adapted to receive communications and media over various wireless networks. Computing device 300 may communicate via wireless policies, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 policies.

The technology described herein has been described in relation to particular aspects, which are intended in all respects to be illustrative rather than restrictive. While the technology described herein is susceptible to various modifications and alternative constructions, certain illustrated aspects thereof are shown in the drawings and have been described above in detail. It should be understood, however, that there is no intention to limit the technology described herein to the specific forms disclosed, but on the contrary, the intention is to cover all modifications, alternative constructions, and equivalents falling within the spirit and scope of the technology described herein.

What is claimed is:

1. One or more computer storage media comprising computer-executable instructions that when executed by a computing device cause the computing device to perform a method of adjusting a textual content to a defined reading level, comprising:
receiving a textual content having an initial reading level;
receiving a desired reading level that is different from the initial reading level;
assigning a part of speech to a word in the textual content;
identifying one or more candidate replacement words that are a synonym for the word in the textual content, the one or more candidate replacement words limited to the part of speech;
determining a reading complexity for the one or more candidate replacement words;
generating a candidate replacement text by replacing the word in the textual content with a replacement word from the one or more candidate replacement words;
determining an updated reading level for the candidate replacement text; and
outputting the candidate replacement text.

2. The media of claim 1, wherein the part of speech is selected from a group consisting of a noun, adjective, and verb.

3. The media of claim 1, wherein the replacement word is selected based on the desired reading level and the reading complexity of the replacement word.

4. The media of claim 1, wherein the method further comprises determining an amount of words in the textual content to replace based on a difference between the initial reading level and the desired reading level.

5. The media of claim 1, wherein the desired reading level is determined based on a meaning, structural, and visual cues (MSV) score of an intended reader.

6. The media of claim 1, wherein the method further comprises:
outputting a text for display;
receiving audio data of the text being read orally by a student;
converting the audio data to converted text;
identifying an error in the converted text by detecting a difference between the converted text the text;
classifying, with a machine classifier, the error into an error category;
generating a reading competency score using the error category; and
determining the desired reading level using the reading competency score and threshold increase.

7. The media of claim 1, wherein the method further comprises, prior to the outputting, determining that the updated reading level is within a threshold of the desired reading level.

8. The media of claim 1, wherein the method further comprises, prior to the outputting, determining that the candidate replacement text is grammatical.

9. A method of adjusting a textual content to a defined reading level comprising:
determining a current reading level for a student;
receiving a textual content having an initial reading level;
determining a desired reading level for the student that is different from the initial reading level;
assigning a part of speech to a word in the textual content;
identifying one or more candidate replacement words that are a synonym for the word in the textual content, the one or more candidate replacement words limited to the part of speech;
determining a reading complexity for the one or more candidate replacement words;
generating a candidate replacement text by replacing the word in the textual content with a replacement word from the one or more candidate replacement words; and
outputting the candidate replacement text to the student.

10. The method of claim 9, further comprising determining an updated reading level for the candidate replacement text.

11. The method of claim 9, further comprising, prior to the outputting, determining an updated reading level for the candidate replacement text and determining that the updated reading level is within a threshold of the desired reading level.

12. The method of claim 9, further comprising, prior to the outputting, determining that the candidate replacement text is grammatical.

13. The method of claim 9, further comprising determining an amount of words in the textual content to replace based on a difference between the initial reading level and the desired reading level.

14. The method of claim 9, wherein the current reading level for the student is based on a MSV score.

15. The method of claim 9, wherein the part of speech is selected from a group consisting of a noun, adjective, and verb.

16. A method of adjusting a textual content to a defined reading level comprising:
receiving a textual content having an initial reading level;
determining a desired reading level for a student that is different from the initial reading level;
identifying a plurality of candidate replacement words that are a synonym for a word in the textual content;
determining a reading complexity for each of the plurality of candidate replacement words;
generating a first candidate replacement text by replacing the word in the textual content with a first replacement word from the plurality of candidate replacement words;
determining that the first candidate replacement text is not grammatical;
generating a second candidate replacement text by replacing the word in the textual content with a second replacement word from the plurality of candidate replacement words;
determining that the second candidate replacement text is grammatical; and
outputting the second candidate replacement text to the student.

17. The method of claim 16, wherein the method further comprises, prior to the outputting, determining an updated reading level for the second candidate replacement text and determining that the updated reading level is within a threshold of the desired reading level.

18. The method of claim 16, wherein the second replacement word is selected based on the desired reading level and the reading complexity of the second replacement word.

19. The method of claim 16, wherein the method further comprises determining the desired reading level using a reading competency score for the student and threshold increase.

20. The method of claim 19, wherein the reading competency score for the student is based on a MSV score.
